(19) United States
(12) Patent Application Publication
(10) Pub. No.: US 2014/0372408 A1
(43) Pub. Date: Dec. 18, 2014

(54) SPARQL QUERY OPTIMIZATION METHOD

(71) Applicant: Eiichiro Chishiro, Tokyo (JP)

(72) Inventor: Eiichiro Chishiro, Tokyo (JP)

(73) Assignee: Hitachi, Ltd.

(21) Appl. No.: 14/374,452

(22) PCT Filed: Jan. 25, 2012
(86) PCT No.: PCT/JP2012/051552

§ 371 Date: Jul. 24, 2014

(51) Int. Cl. G06F 17/30

(52) U.S. Cl. CPC G06F 17/30442; G06F 17/30292
USPC 707/715

(57) ABSTRACT

Prior to query execution a compressed table and compressed RDF data are created by use of: RDF data stored in an external storage device; and a compression reference table entered from an input device. The compression reference table is used to create a compressed query from an original query entered from the input device, and the compressed RDF data is searched to generate a variable biding table. An expanded query having a node added thereto is next created by use of the original query and the variable binding table, the node restricting a variable value range. The expanded query and the original RDF data are used to generate a query execution result at last.

### TECHNICAL FIELD

The present invention relates to SPARQL query processing in a RDF store.

### BACKGROUND ART

In recent years a format called the RDF (Resource Description Framework) is standardized in the W3C (World Wide Web Consortium) as a unified data format for cross-category search and analysis of a wide variety of data such as image, audio, and document, and the use of RDF is becoming widespread. All data is represented by a set of triplets of values called a triple in the RDF. The values of the triplet are sequentially called subject, predicate, and object. The value of the subject and the predicate is an identifier that is called a resource and is unique on the Internet. The value of the object is a resource or specific value such as a string, a numerical value and date that are called literal. The resource and the literal are collectively referred to as a node. The resource is an entity and the literal is an attribute. For example, a node is a resource and information relating to this node is a literal in a graph.

An example of RDF data is shown in FIG. 2. This example shows information on the name, age, and sex of three company members. One row corresponds to one triple (record). Strings beginning with “http://” are resources and the others are literals. For example, in the first triple in FIG. 2, “http://hitachi/ldap/1” and “http://name” are resources and “Michael Adams” is a literal. This triple shows that the name of the company member identified according to “http://hitachi/ldap/1” is “Michael Adams”.

A database system that stores RDF data is called an RDF store. A standard RDF store has a function to search data using a query language called the SPARQL. The SPARQL is a query language equivalent to the SQL in a relational database system. A user can acquire data by describing the conditions of data to be obtained as a SPARQL query and inputting it to the RDF store.

The following is an example of the SPARQL query.

```
      select ?n ?a where {
        ?x <http://name> ?n. ?x <http://age> ?a. filter (?a >
30).
      }
```

This query is to acquire the name and age of employees whose age is older than or equal to 30 years old. In the query, the resource is so described as to be enclosed by “<” and “>” and the literal is so described as to be enclosed by ‘″’. Strings beginning with ? (such as ?n, ?x, and ?a here) represent variables; ?x <http://name> ?n. and ?x <http://age> ?a. in the query are conditional clauses called a triple pattern and specify a triple that corresponds through replacement of the variable by an appropriate value; and filter (?a>30). is a conditional clause called a filter pattern and represents a restriction that should be satisfied by the value of the variable.

When the query is executed, the values of the variables that satisfy all conditions specified after “where” are retrieved and the values of the respective variables lined after “select” (n and a in the above-described example) are returned as a result. The correspondence between the variable and the value thereof as the result of the query is referred to as variable binding. If the values of variables that satisfy conditions exist in plurality, the result is a set of variable binding.

For example, the result of the execution of the above query for the RDF data of FIG. 2 is (?n=“John Smith”, ?a=“32”) and (?n=“Anne Brice”, ?a=“45”), and the correspondence between these variables and the values is variable binding. The method of executing the SPARQL query is described in Section 12 of non-patent literature 1.

To widely perform data analysis, the amount of data stored in the RDF store has been increasing in scale year by year. In general, the execution efficiency (search efficiency) of the query decreases as the amount of targeted data increases. In particularly with a query for advanced data analysis, the execution time tends to be long because condition specifying is complicated. Therefore, a method to optimize the SPARQL query to enhance the execution efficiency is required.

Patent document 1 is a method to optimize the SPARQL query. The method shown in patent document 1 is a method in which the execution efficiency of the query is enhanced by analyzing the SPARQL query and restricting the search range. In this method, RDF data is divided in advance into several partitions on the basis of the value of the data. A query, once input to the RDF store, is analyzed and executed with restriction to the related partition. The efficiency in the execution of the query is generally higher when the search range as the target is smaller. Therefore, the efficiency can be enhanced by narrowing the number of target partitions.

The selection of the partition relating to the query is carried out according to a set C of constant values included in the query. The partitions having no relation to the query execution can be excluded by calculating in advance a set Ci of constants included in each partition Pi and comparing it with C.

### CITATION LIST

### Patent Literature

PTL 1: U.S. Pat. No. 7,987,179

### Non-Patent Literature

Non-patent Literature 1: http://www.w3.org/TR/rdf-sparql-query/

### SUMMARY OF INVENTION

### Technical Problem

However, in the method of the above-described document 1, the restriction of the search range is carried out on the basis of only constants included in the query. The restriction effect thereof is not sufficient because the search range of the query does not necessarily match the partition division of the RDF data. In particular, it is impossible to restrict the search range for a query like the following one, the query specifying desired data according to constraint conditions on variables.

```
select ?l1 where {
  ?s1 degree ?d1. ?s1 label ?l1.
  filter regex(?l1, ”breast.*cancer”).
  ?s2 degree ?d2. ?s2 label ?l2.
  filter (?d1 < ?d2).
}
```

This is a query to search for a case severer than the breast cancer from a case database. For this query, the severity (value of degree) of all cases needs to be compared in order to search for a case that satisfies the constraint condition of filter (?d1<?d2). The efficiency of the search rapidly worsens when the target range of the search becomes wider. Using the method of patent document 1 can restrict the search range to a range including “degree” and “label”. However, they are included in most case data and the search range will be hardly narrowed.

Such a query is frequently used in data analysis, and hence, a method that can efficiently execute the query even for large-scale data is required.

An object of the present invention is to provide a method to restrict the search range for a data analysis-related SPARQL query that specifies data to be obtained according to such a constraint condition between variables and efficiently execute the query on large-scale data.

### Solution to Problem

In the present invention, contracted RDF data obtained by decreasing the number of original RDF data is generated in advance in procedure shown below. A query obtained by optimizing the original query by use of the generated data, i.e. creating and executing a query to which a conditional clause that restricts the search range is added. The execution efficiency of the query is thereby enhanced.

A contraction base table in which a basis to associate plural literals similar in the attribute in RDF data held by an RDF store with one value referred to as a contracted literal is defined is first received from an input device.

The contraction base table includes three items of base predicate, contracted literal, and contraction range. An example of the contraction base table is shown in FIG. 9B. The names of resources are written in the base predicate. Arbitrary values (strings) associated with the resources are written in the contracted literal. Conditional expressions that are associated with the contracted literals and relate to a variable X are written in the contraction range. Each row means that, if a literal L present at the object position in a triple having the base predicate at the predicate position satisfies the condition written in the contraction range, L is associated with the contracted literal written on this row. Whether the literal satisfies the condition is determined on the basis of whether an expression obtained by replacing X by the literal is true.

Then, a processor creates a contraction table to associate plural resources included in the RDF data with one contracted literal with reference to the contraction base table. Next, the contracted RDF data obtained by integrating plural nodes of the RDF data into one node is created with the use of the contraction base table and the contraction table. At the same time, at least one triple representing the correspondence relation between the node of the RDF data and the contracted RDF node is added to the RDF data (triple in which resource and contracted literal in FIG. 10A are connected by “abs” is added to the RDF data).

The contracted RDF data created in this manner keeps the connection between nodes in the RDF data. Specifically, if a triple {n1 (subject), n2 (predicate), n3 (object)} is included in the RDF data and the contracted literals of n1, n2, and n3 with respect to plural RDF data are a1, a2, and a3, respectively, it is ensured that a triple (a1, a2, a3) is included in the contracted RDF data.

Meanwhile, the contracted RDF data, created by integrating plural nodes of the RDF data into one node, has a smaller number of data than the RDF data. If N nodes are integrated into one on average, the size of the contracted RDF data becomes 1/N of the size of the original RDF data. By using such a contraction base table as to make N sufficiently large, the search time for the contracted RDF data can be shortened to an ignorable level compared with the case of the original RDF data.

A SPARQL query is next received from the input device and a contracted query obtained by replacing a literal in the input query by a corresponding contracted literal with reference to the contraction base table is generated. The contracted RDF data is then searched by use of the contracted query and a variable binding table (correspondence relation between the respective variables in the query and contracted literals, FIG. 13) in which a contracted literal possessed by each variable in the query is recorded is created.

As described above, the contracted RDF data keeps the connection between nodes in the original RDF data. If the value of the variable x is a contracted literal “a” when a search is carried out for the contracted RDF data by use of the contracted query q, the value of x when the same original query q is executed for the original RDF data is surely a value contracted to “a”. Accordingly, it turns out that it only needs to check only a value contracted to “a” as the value of the variable x.

An expanded query obtained by adding, to the original query, a variable node of restricted range that specifies a contracted literal possessed by each variable is subsequently created by use of the generated variable binding table. At last, the RDF data corresponding to the contracted RDF data is searched with the use of the created expanded query and a search result is obtained accordingly.

### Advantageous Effects of Invention

The original query is converted to the contracted query in which the range of the value of the variable that needs to be checked at the time of a search is restricted to a range corresponding to a specified contracted literal. The contracted RDF data obtained by converting plural data to a contracted literal by which the range of the value of a variable is specified is searched with the converted query. The search efficiency of the query to large-scale RDF data is particularly enhanced as a result.

### BRIEF DESCRIPTION OF DRAWINGS

FIG. 1 is a diagram showing an example of RDF data.

FIG. 2 is a configuration diagram of the present invention.

FIG. 3 is a diagram showing the flow of RDF data contraction processing.

FIG. 4 is a diagram showing the flow of creation of a contraction table.

FIG. 5 is a diagram showing the flow of creation of contracted RDF data.

FIG. 6 is a diagram showing the flow of overall query processing.

FIG. 7 is a diagram showing the flow of query conversion processing.

FIG. 8 is a diagram showing the flow of query expansion processing.

FIG. 9A is a diagram showing RDF data used in a working example.

FIG. 9B is a diagram showing a contraction base table used in the working example.

FIG. 9C is a diagram showing a query used in the working example.

FIG. 10A is a diagram showing a contraction table used in the working example.

FIG. 10B is a diagram showing contracted RDF data used in the working example.

FIG. 11A is a diagram showing a contracted query used in the working example.

FIG. 11B is a diagram showing a variable binding table used in the working example.

FIG. 11C is a diagram showing an expanded query used in the working example.

FIG. 11D is a diagram showing a query result used in the working example.

FIG. 12 is a diagram showing the overview of search processing.

### DESCRIPTION OF EMBODIMENT

One example of an embodiment of the invention will be described below with the use of the drawings.

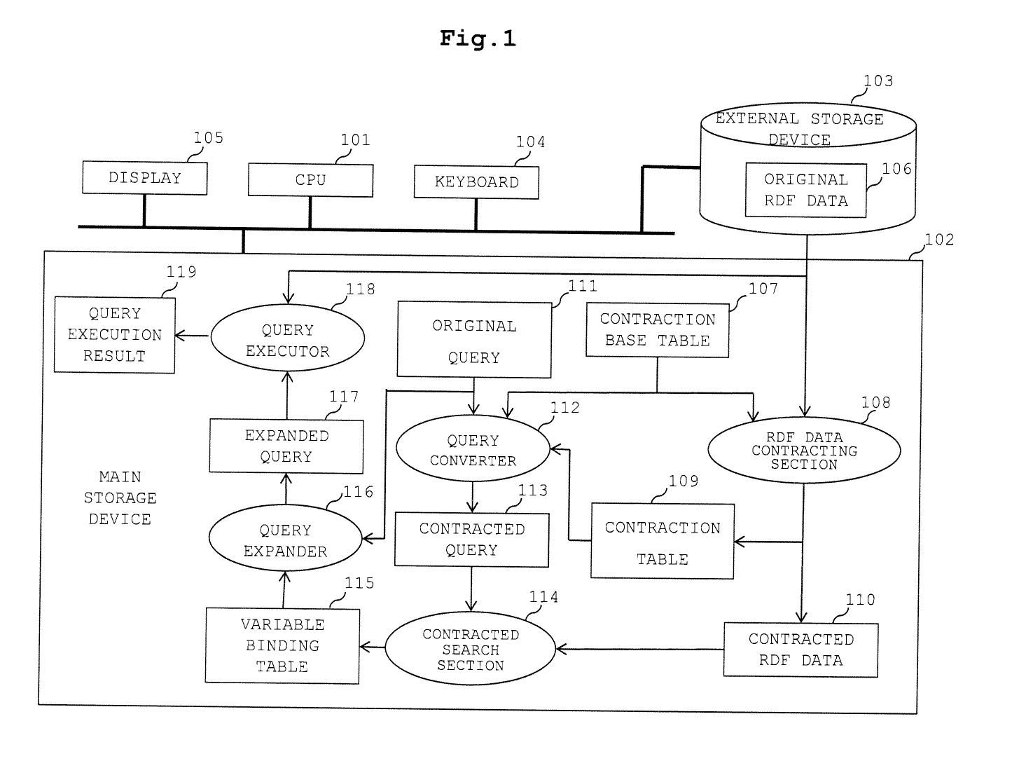

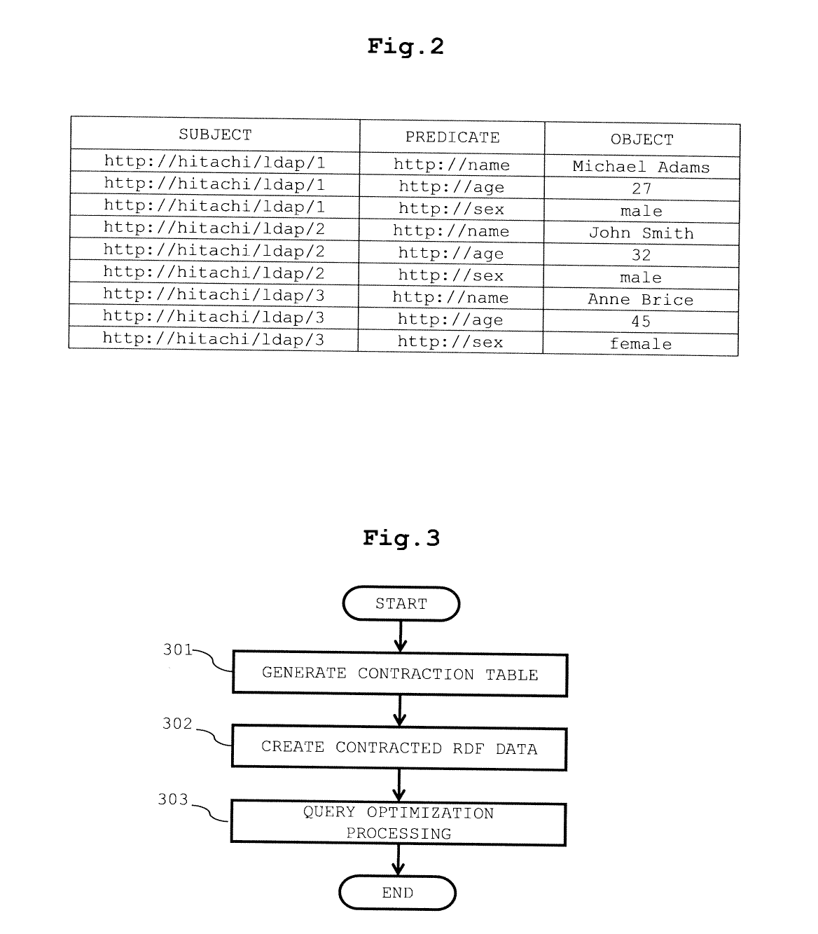

FIG. 1 is a diagram showing a configuration example of a computer system in which a SPARQL optimization device operates. Arrow lines represent the flow of data.

As shown in the diagram, the computer system includes a CPU 101, a main storage device 102, an external storage device 103, an input device 104 such as a keyboard, and an output device 105 such as a display device.

Original RDF data 106 managed by an RDF store is stored in the external storage device 103.

The following elements are stored in the main storage device 102: a contraction base table 107 input from the input device 104; an RDF data contracting section 108 that creates a contraction table 109 and contracted RDF data 110 using the RDF data 106 and the contraction base table 107; a query converter 112 that creates a contracted query using an original query 111 input from the input device 104 and the contraction base table 107; a contracted search section 114 that creates a variable binding table 115 using the contracted query 113 and the contracted RDF data 110; a query expander 116 that creates an expanded query 117 using the original query 111 and the variable binding table 115; and a query executor 118 that creates a query execution result (search result) 119 using the expanded query 117 and the RDF data 106.

The definitions of the above-described respective terms will be shown below.

(1) The contraction base table 107 is a basis defined in order to associate plural literals (characters) or resources (numerical values) in the RDF data with one value called a contracted literal.
(2) The contraction table 109 is to associate plural resources included in the RDF data with one contracted literal.
(3) The variable binding table 115 is to show the correspondence relation between the respective variables in the query and contracted literals. The contracted query 113 is obtained by replacing literals in the input original query by corresponding contracted literals with the use of the contraction base table.
(4) The expanded query 117 is obtained by adding to the original query a variable node of restricted range that specifies the contracted literal each variable possesses.
(5) The contracted RDF data 110 is data obtained by integrating plural nodes (collective term of resource and literal) in the original RDF data into one node with reference to the contraction base table and the contraction table.

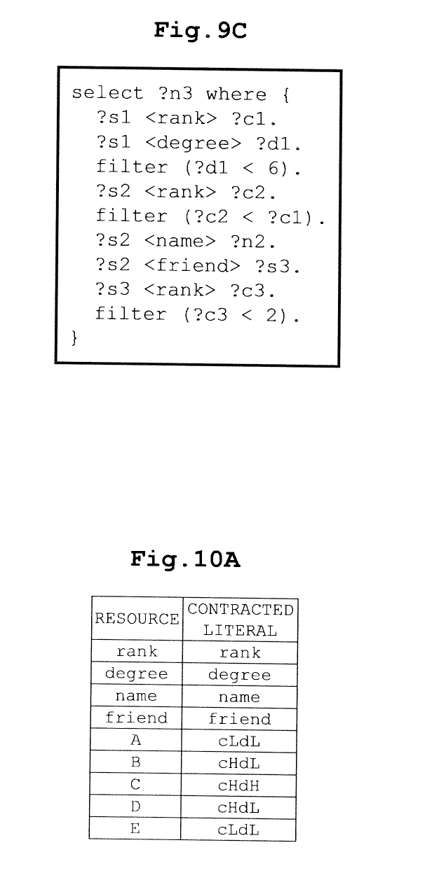

Prior to description of the processing, the respective data used in the processing, shown in FIGS. 9, 10, and 11, will be described.

FIGS. 9A, 9B, and 9C are diagrams showing RDF data used as an example, a contraction base table, and a query, respectively.

FIG. 9A represents the RDF data used as an example in a format of a three-column table. Each row corresponds to one triple. The first column, second column, and third column represent the subject, predicate, and object, respectively. This RDF data represents the rank, degree, name, and friend (friendship) of five countries A, B, C, D, and E.

FIG. 9B is the contraction base table used as an example. Two predicates, “rank” and “degree”, are recorded as base predicates. The contracted literals of “rank” are cL and cH, which correspond to values smaller than 2 and values larger than or equal to 2, respectively. This means that the value of “rank” smaller than 2 is contracted to cL and the value of “rank” larger than or equal to 2 is contracted to cH. Similarly, the contracted literals of “degree” are dL and dH, which correspond to values smaller than 10 and values larger than or equal to 10, respectively. This means that the value of “degree” smaller than 10 is contracted to dL and the value of “degree” larger than or equal to 10 is contracted to dH.

FIG. 9C is a SPARQL query (original query) used as an example. This query is to search for the name (?n2) of a country whose rank (?c3) is lower than 2 among countries (?s3) having friendships with a country (?s2) with a rank lower than the rank (?c1) of a counter (?s1) whose degree (?d1) is lower than 6. By expressing statistical data opened to the public by countries around the world as RDF data in a unified manner in advance, such an international complicated data analysis can be easily performed with the use of the SPARQL query. Meanwhile, the RDF data made by collecting various statistical data of countries around the world has a significantly large scale and therefore efficient query processing is necessary in practical use.

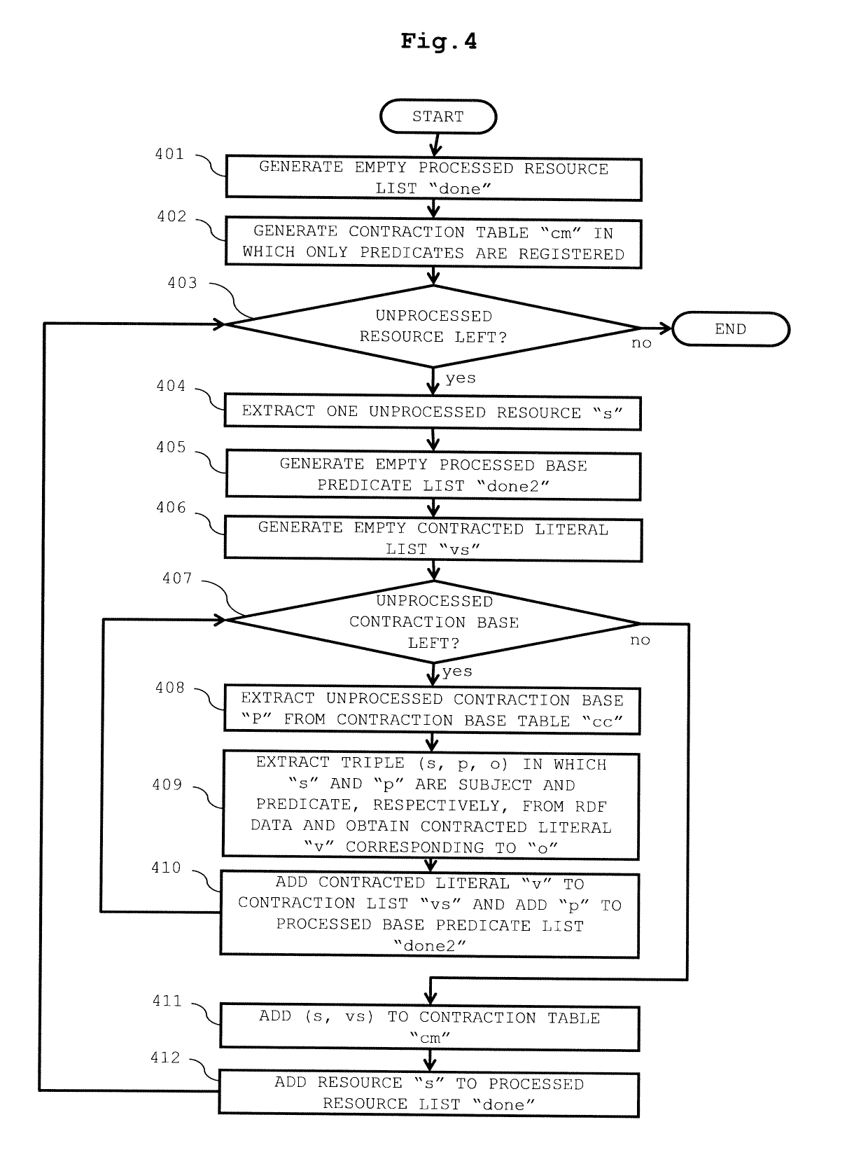

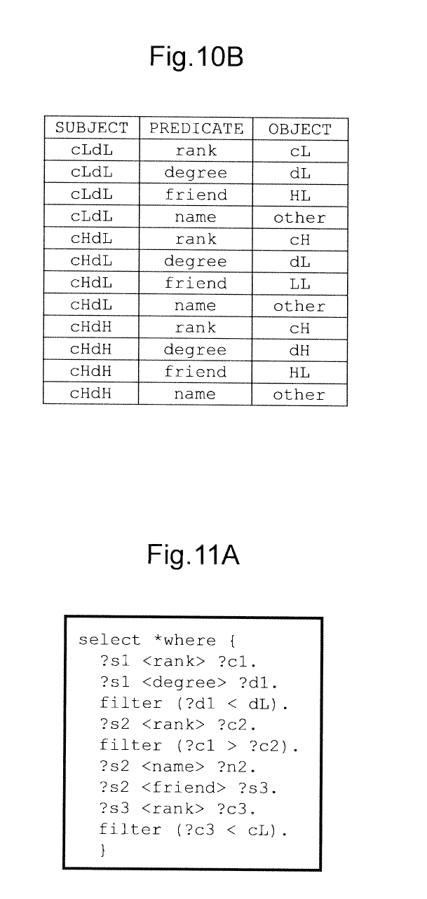

FIG. 10A is a contraction table generated from the RDF data of FIG. 9A and the contraction base table of FIG. 9B as a result of the processing of FIGS. 3 to 5 in the present invention. FIG. 10B is contracted RDF data.

In a step 301 to be described later, the contracted literals of all resources in the original RDF data (FIG. 9A) are obtained in accordance with the contraction base table (FIG. 9B) given as an input, and the contraction table (FIG. 10A) in which the correspondence relation between the original resources and the contracted literals is recorded is generated.

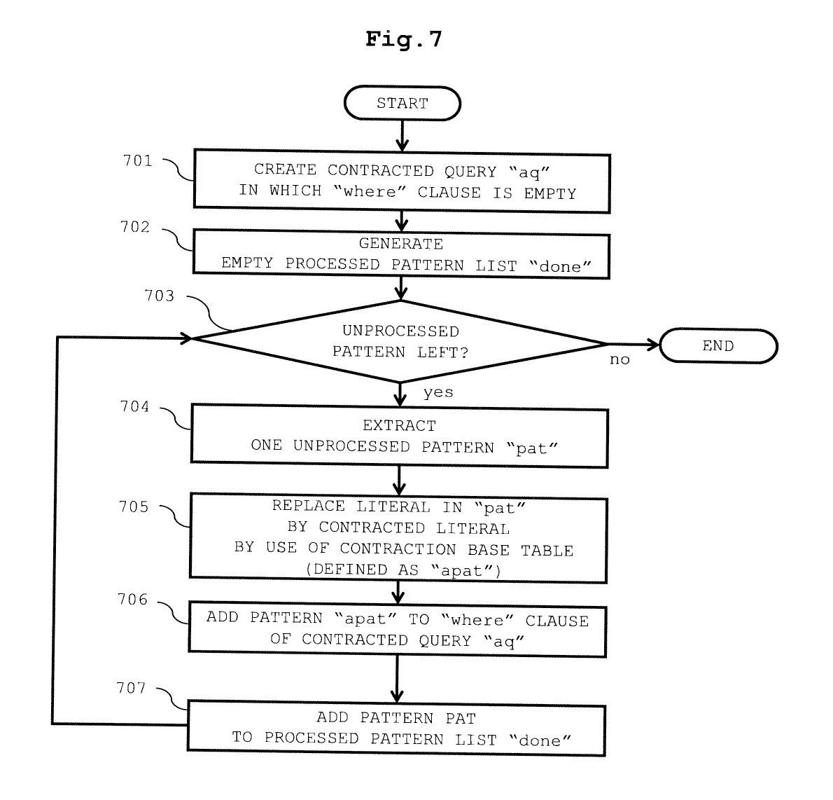

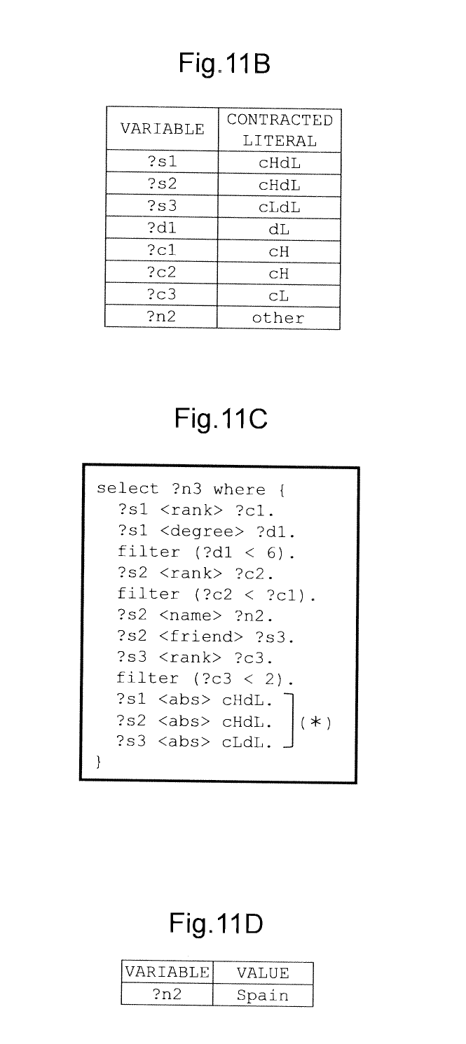

FIGS. 11A to D are a contracted query (FIG. 9A), a variable binding table (FIG. 9B), an expanded query (FIG. 9C), and a search result (FIG. 9D), respectively, created from the query of FIG. 9C as a result of the processing of FIGS. 6 to 8 in the present invention. FIG. 11A is the contracted query obtained by converting the input query of FIG. 9C and replacing the literals in the query by the corresponding contracted literals. FIG. 11B is the variable binding table in which the contracted literals of the respective variables in the query (variable binding) as a search result obtained by searching the contracted RDF data of FIG. 10B using the contracted query are associated with the variables. FIG. 11C shows the expanded query in which the search range is restricted through expansion of the input query of FIG. 9C using the result of FIG. 11B. “*” in FIG. 11C is the restriction part of the search range. FIG. 11D is the search result (variable and value thereof) obtained by searching the RDF data of FIG. 9A with the use of the expanded query of FIG. 11C.

FIG. 3 is a flowchart showing the overall processing including RDF data contraction processing.

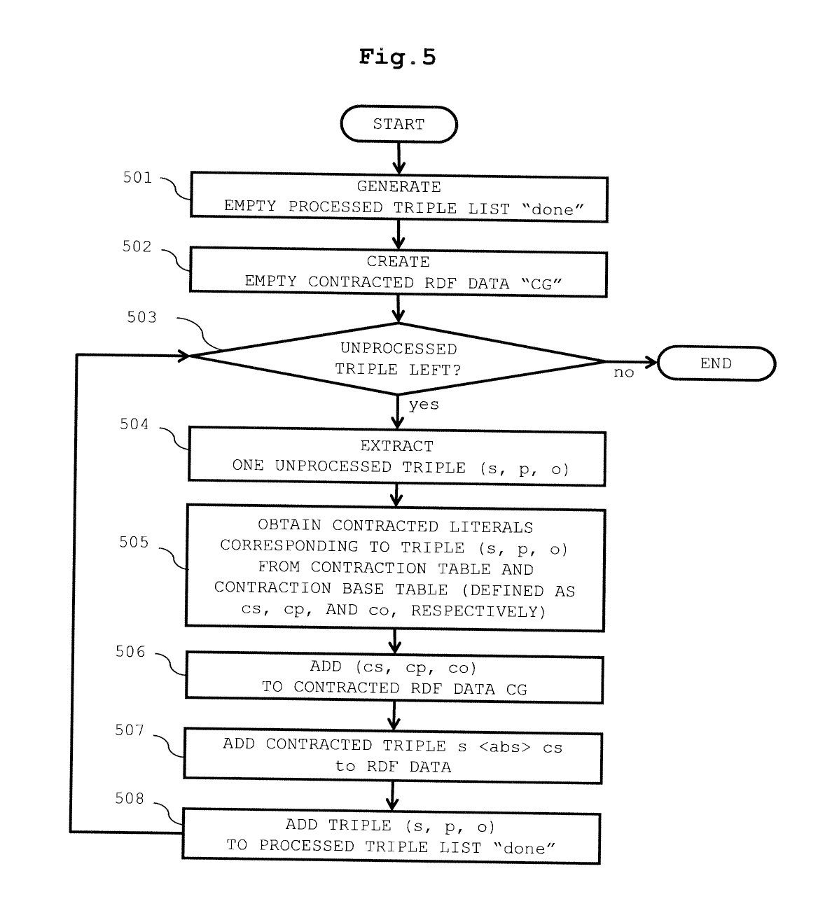

First, in the step 301, the contracted literals of all resources in original RDF data are obtained according to a contraction base table given as an input, and a contraction table in which the correspondence relation between the original resources and the contracted literals is recorded is generated (FIG. 4).

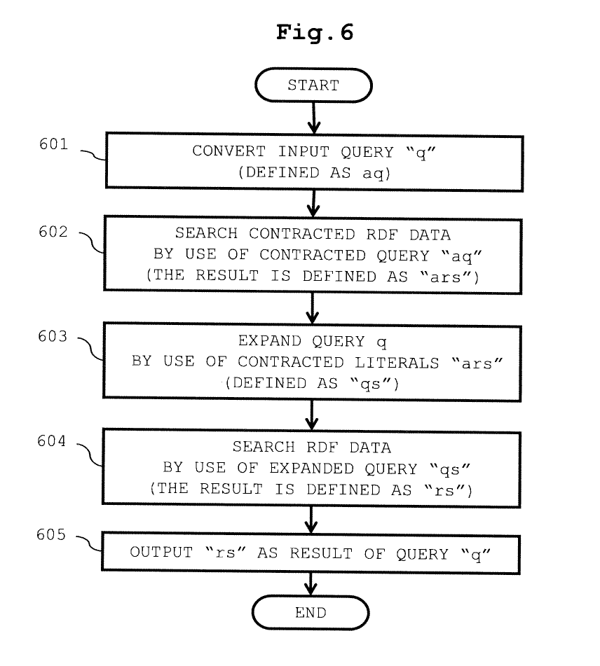

Next, the processing proceeds to a step 302 to contract the original RDF data using the generated contraction table to create contracted RDF data (FIG. 5).

At last, in a step 303, query optimization processing to optimize an input query on the basis of the search result of the contracted RDF data and search the RDF data is executed (FIG. 6).

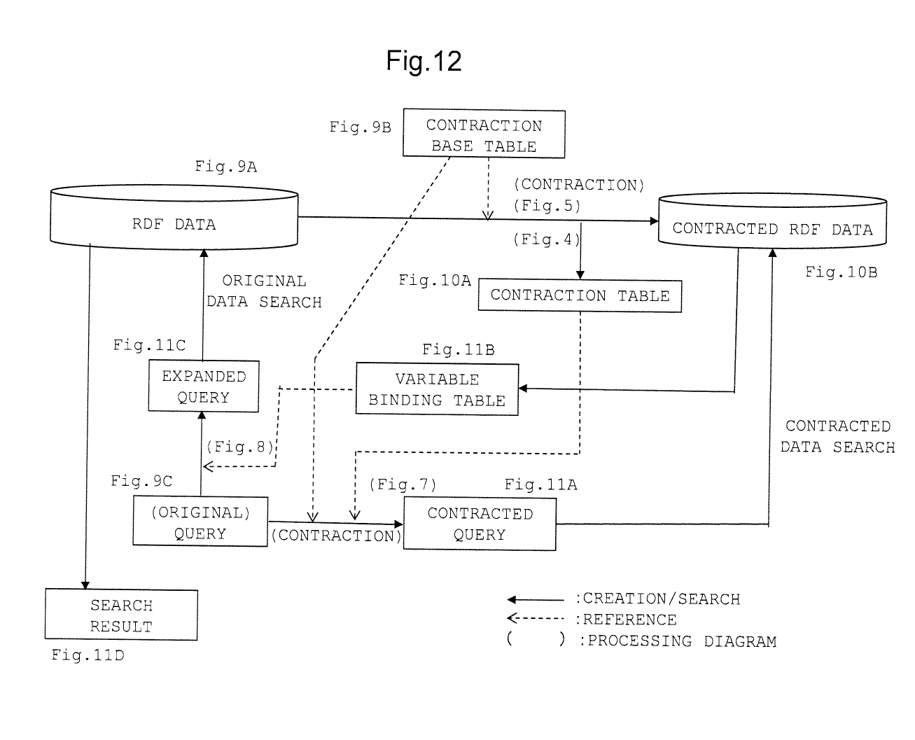

The outline of the search processing based on the respective data will be described with the use of FIG. 12 here.

(1) Prior to the search of the RDF data by use of the query, the contracted RDF data obtained by contracting the RDF data is generated with the contraction base table. At this time, the contraction table showing the correspondence relation between both data is generated.

(2) The contracted RDF data is searched by use of the contracted query created from the (original) query using the contraction table and the contraction base table, and the variable binding table is generated as the search result.

(3) The expanded query is generated from the (original) query by restricting the search range using the variable binding table. RDF data is searched with the expanded query to obtain the search result.

That is, the contracted RDF data obtained by contracting the RDF data is searched with the use of not the (original) query but the contracted query thereof in the present invention. And the RDF data is searched with the expanded query arising from conversion of the (original) query by use of the variable binding table obtained as the result of the search of the contracted RDF data.

FIG. 4 is a flowchart detailing the processing of the step 301.

First, in a step 401, a list for recording processed resources is created (defined as “done” which means that processing has been executed) in order to store and distinguish processed resources. Next, the processing proceeds to a step 402 to generate an empty contraction table and register the same values (resource names) of all predicate resources included in the original RDF data as the resources extracted from the RDF data in the contraction table as contracted literals. In particular, in the case of the predicate resource, the resource and the contracted literal are the same and they are registered as a pair as shown in the first to fourth rows in FIG. 10A.

The predicate resource here refers to the resource that appears as the predicate (second element) of a triple in the original RDF data. A plurality of predicate resources are not contracted to one in the present invention, and therefore, the same value as the original resource is used as the contracted literal.

Next, the processing proceeds to a step 403 to check whether an unprocessed resource is left in the original RDF data. If an unprocessed resource does not exist, the contraction table has been completed and thus the processing is terminated. If an unprocessed resource remains, the processing proceeds to a step 404 to extract one resource (defined as s). The contracted literal of the resource s is obtained through sequential checking with all base predicates recorded in the contraction base table on each resource basis (steps 405 to 410).

First, the processing proceeds to the step 405 to make an empty list representing processed base predicates. Next, the processing proceeds to the step 406 to make an empty string representing the contracted literal of the resource s (list of the contracted literal of the resource s is defined as vs).

In the present invention, as the contracted literal of a resource that is not a predicate, contracted literals for the respective base predicates are sequentially stored in the contraction table of FIG. 10A with the contraction base table. This makes it possible to distinctively treat a resource having even at least one base predicate with different contracted literal, treating like resources shown on the fifth to tenth rows in FIG. 10A, which are not a predicate.

The processing next proceeds to the step 407 to check whether an unprocessed base predicate is remaining. If an unprocessed base predicate is left, the processing proceeds to the step 408 to extract one base predicate (defined as p). Hereinafter, designations corresponding to subject, predicate, and object of the RDF data shown in FIG. 10A are defined as s, p, and o, respectively, and symbols of the contracted literals of them are defined as cs, cp, and co, respectively.

The processing subsequently proceeds to the step 409 to extract a triple (s, p, o) including s and p as subject and predicate from the original RDF data and obtain the contracted literal of the object o (defined as co) on the basis of the contraction base table. The processing then proceeds to the step 410 to add co (contracted literal of the object o) to vs (list of the contracted literal of the resource s) and add p (unprocessed base predicate) to the processed base predicate list (done 2), followed by return to the step 407.

If an unprocessed base predicate does not exist in the step 407, the contracted literal of the subject s has been obtained, and then, the processing proceeds to a step 411.

In the step 411, that the contracted literal of the subject s is vs is recorded in the contraction table. Next, the processing proceeds to a step 412 to add the subject s to the processed resource list, followed by return to the step 403.

FIG. 5 is a flowchart detailing the contracted RDF data generation processing of the step 302. The contracted RDF data is generated by contracting each triple of the original RDF data on the basis of the contraction table made at the step 301 and the contraction base table.

First, in a step 501, a list in which to record processed triples is created (defined as “done”). Next, the processing proceeds to a step 502 to create empty contracted RDF data shown in FIG. 10B (defined as CG).

Next, the processing proceeds to a step 503 to check whether an unprocessed triple is left in the original RDF data. If an unprocessed triple does not exist, the contracted RDF data generation processing is terminated. If an unprocessed triple is left, the processing proceeds to a step 504 to extract one triple {defined as (s, p, o)}.

Next, the processing proceeds to a step 505 to obtain contracted literals corresponding to s, p, and o from the contraction table and the contraction base table (defined as cs, cp, and co). Due to the specifications of the RDF, s and p are resources and o is a resource or literal. If o is a resource, the corresponding contracted literal is extracted since the contracted literal of the resource has been recorded in the contraction table. If o is a literal, the contracted literal is obtained according to the input contraction base table similarly to the step 409 in FIG. 4 when p is a base predicate. When p is not a base predicate, “other” representing all other values is employed as the contracted literal.

Next, the processing proceeds to a step 506 to add a triple (cs, cp, co) composed of the obtained contracted literals cs, cp, and co to the contracted RDF data (CG). Next, the processing proceeds to a step 507 to add, to the original RDF data, a triple (s, abs, cs) representing the correspondence between the resource s and the contracted literal cs thereof. This is used to restrict the search range at the time of query execution (at the time of a search). “abs” is a predicate that associates the original data with the contracted literal. Next, the processing proceeds to a step 508 to add (s, p, o) to the processed triple list “done”, followed by return to the step 503.

FIG. 6 is a flowchart showing the flow of the query optimization execution processing 303. In this processing a query input to the RDF store is optimized with the use of the contraction table and the contracted RDF data generated by the contraction processing of FIG. 3, to create a query in which the search range is restricted. The original RDF data is searched with the created query and its search result is output. The “optimization” here is to create a query to which a conditional clause that restricts the search range is added from the (original) query.

First, in a step 601, an input query q is converted to create a contracted query obtained by replacing literals in the query by the corresponding contracted literals (defined as aq).

Next, the processing proceeds to a step 602 to search the contracted RDF data with the contracted query aq to obtain the contracted literals of the respective variables in the query (defined as ars). The search of the contracted RDF data by use of the contracted query is almost similar to normal query processing that is executed by the RDF store since the contracted RDF data is in the RDF format. The search is based on the definition of non-patent literature 1, i.e. processing of extracting a triple matching the query from a list of triples. The difference is only determination processing of a comparison expression in the filter clause.

In unequal value comparison v1 !=v2 (“!=” is the same as “≠”) between contracted literals v1 and v2, the expression is determined to be false if the values of v1 and v2 are the same and is determined to be true if not in the normal query processing. However, the values before the contraction are not necessarily the same even when the literals are the same in the case of the contracted literals. The expression is always determined to be true accordingly. In magnitude comparison v1<v2 between the contracted literals, the ranges of the original values corresponding to v1 and v2 are checked with reference to the contraction base table and determination is made on the basis of the magnitude relation therebetween. For example, the result of v1<v2 is determined to be true if it is written in the contraction base table that the range of the original value corresponding to v1 is smaller than or equal to 20 and the range of the original value corresponding to v2 is larger than or equal to 50. This applies also to other kinds of magnitude comparison (v1>v2, v1<=v2, or v2<=v1). These corrections can prevent the result of the query from changing due to the optimization. That is, the occurrence of search imperfection due to the restrictive condition added to an expanded query can be prevented.

Next, the processing proceeds to a step 603 to expand the input query q using the contracted literals ars of the respective variables in the query, i.e. add a variable node of restricted range to the query, to create the expanded query in which the search range is restricted (defined as qs).

Next, the processing proceeds to a step 604 to search the original RDF data using the expanded query qs to obtain values corresponding to the respective variables in the query (search result) (defined as rs). This is the same as the normal query processing executed by the RDF store. The processing then proceeds to a step 605 to output the values rs corresponding to the respective variables in the query as the search result, such that the processing is terminated.

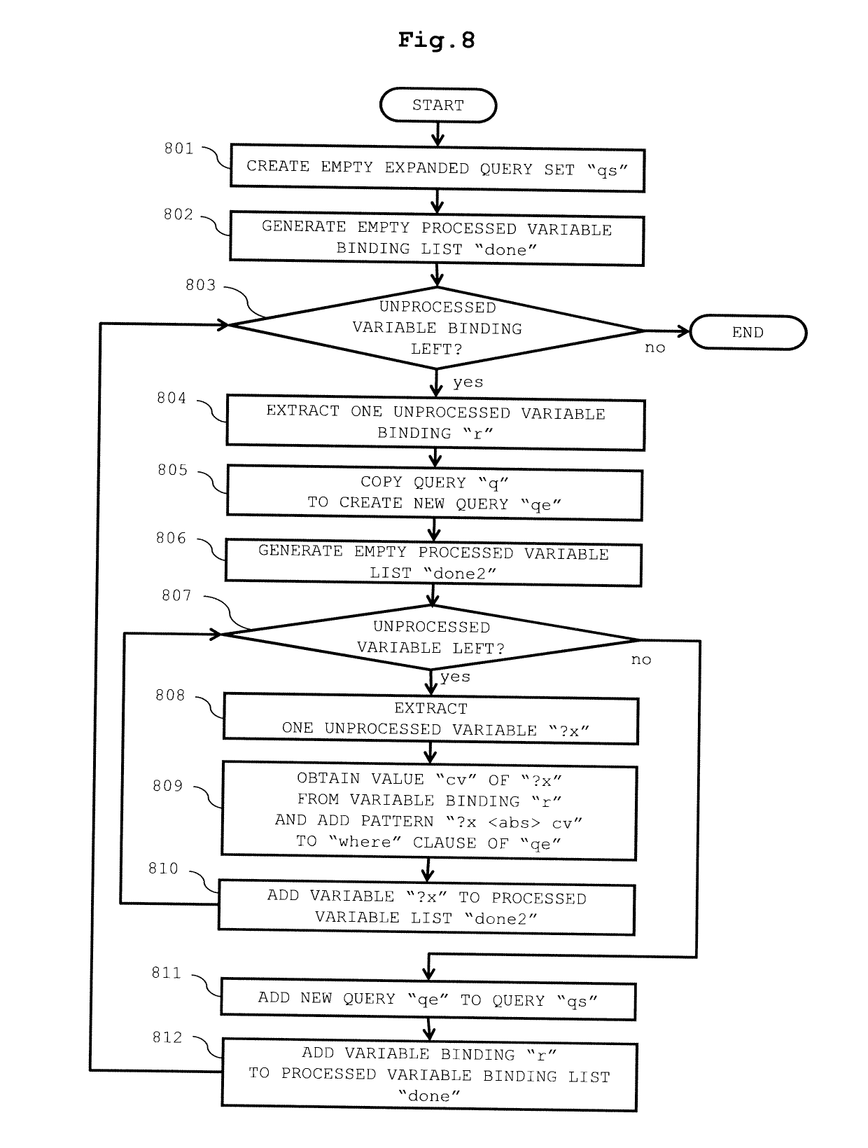

FIG. 7 is a flowchart showing the query conversion processing of the step 601 in detail. The query conversion processing is executed by converting values included in the original query to contracted literals for patterns (conditional clauses) written in the “where” clause of the original query one by one.

First, in a step 701, the contracted query having the variable node of the original query q turned to * and having the “where” clause empty is created (defined as aq). The purpose of turning the variable node to * is to obtain the contracted literals of all variables in the query. Next, the processing proceeds to a step 702 to make an empty list (FIG. 11A) in which to record processed patterns (defined as “done”).

Next, the processing proceeds to a step 703 to check whether an unprocessed pattern is remaining in the data of FIG. 11A. If an unprocessed pattern does not exist, the query conversion processing is terminated. If an unprocessed pattern is left, the processing proceeds to a step 704 to extract one pattern (defined as pat).

Next, the processing proceeds to a step 705 to create a pattern obtained by replacing a literal included in pat by a contracted literal with the use of the contraction base table (defined as apat). How to obtain the contracted literal is the same as that of the step 409 in FIG. 4. The predicate that is not a variable is employed as the base predicate if the literal is included in a triple pattern (conditional clause in which part of a triple is a variable, conditional clauses that are not given “filter” on the second, third, fifth, and seventh to ninth rows in FIG. 11A) and the predicate is not a variable. On the contrary, the predicate that is not the variable is employed as the base predicate if the literal is included in the comparison expression of the filter pattern and a triple pattern including the variable of the comparison counterpart as the object exists. If the present case corresponds to neither of the cases, a filter pattern “filter (1=1)” which is always true is produced.

Next, the processing proceeds to a step 706 to add the pattern apat obtained by replacing the literal by the contracted literal to the “where” clause of the contracted query aq. Next, the processing proceeds to a step 707 to add pat, which is an unprocessed pattern, to the processed pattern list “done”, followed by return to the step 703.

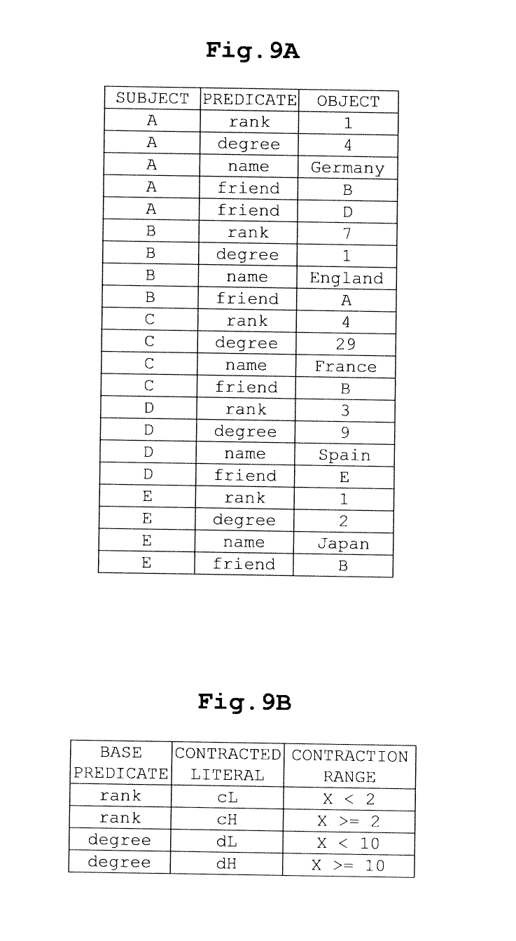

FIG. 8 is a flowchart showing the query expansion processing of the step 603 in detail.

First, in a step 801, an empty expanded query set is created (defined as qs). Next, the processing proceeds to a step 802 to make an empty list in which to record processed variable binding (FIG. 11C, it is to store the expanded query) (defined as “done”).

Next, the processing proceeds to a step 803 to check whether unprocessed variable binding is remaining. If unprocessed variable binding does not exist, the query expansion processing is terminated. If unprocessed variable binding is left, the processing proceeds to a step 804 to extract one variable binding (defined as r).

Next, the processing proceeds to a step 805 to copy the original query q to create a new query (defined as qe). In the query expansion processing the expanded query in which the search range is restricted is created by adding a pattern that restricts the range of the value of a variable to the new query qe obtained by copying the original query (step 806 to step 810).

When a search is conducted with a filter pattern as it is, it takes a long time to compare the values of two variables. The range of the value of the check target, however, is restricted by the variable node of restricted range in the expanded query. Thus, the time of the comparison between the values of two variables is shortened with the above-described processing.

First, the processing proceeds to the step 806 to make an empty list in which to record processed variables (defined as “done2”).

Next, the processing proceeds to the step 807 to check whether an unprocessed variable is remaining. If an unprocessed variable does not exist in the step 807, the processing proceeds to a step 811 to add the created expanded query qe to the expanded query set qs. In the expanded query set, expanded queries of queries different from each other in the variable node of restricted range are stored. Next, the processing proceeds to a step 812 to add the variable binding r to the processed variable binding list “done”, followed by return to the step 803.

If an unprocessed variable is remaining in the step 807, the processing proceeds to the step 808 to extract one variable (defined as ?x). Next, the processing proceeds to the step 809 to obtain a value cv of the variable ?x recorded in the variable binding r and add a pattern “?x <abs> cv.” to the “where” clause of the expanded query qe. Next, the processing proceeds to the step 810 to add the variable ?x to the processed variable list “done2”, followed by return to the step 807.

### (Specific Example of Processing)

In the following, a working example of the present invention will be shown with the use of a specific example.

The processing of the step 301 will be described along the flowchart shown in FIG. 4.

First, in the step 401, a list in which to record processed resources is made (defined as “done”). Next, the processing proceeds to the step 402, where an empty contraction table is produced, and the same values (resource names) of all predicate resources included in the original RDF data as the original resources are recorded as contracted literals and registered in the processed resource list “done”. From the column of the predicate in the RDF data of FIG. 9A, four predicates of “rank”, “degree”, “name”, and “friend” are obtained as predicate resources. Pairs of resource and contracted literal thereof, i.e. (rank, rank), (degree, degree), (name, name), and (friend, friend) are registered in the contraction table. Further, “rank”, “degree”, “name”, and “friend” are registered in the processed resource list “done”.

Next, the processing proceeds to the step 403 to check whether an unprocessed resource is remaining in the original RDF data. As unprocessed resources are left, the processing proceeds to the step 404 to extract one resource. Suppose that the subject A has been extracted here.

Next, the processing proceeds to the step 405 to make an empty list representing processed base predicates (defined as “done2”). The processing then proceeds to the step 406 to produce an empty list representing the contracted literal of the subject A (defined as vs).

Next, the processing proceeds to the step 407 to check whether an unprocessed base predicate is remaining. As “rank” and “degree” are left as unprocessed base predicates, the processing proceeds to the step 408 to extract one base predicate. Suppose that “rank” has been extracted here.

Next, the processing proceeds to the step 409 to extract a triple in which A is the subject and “rank” is the predicate from the original RDF data. Here, (A, rank, 1) is extracted. As 1 is smaller than 2, it turns out that the contracted literal thereof is “cL” from the contraction base table. The processing then proceeds to the step 410 to add the contracted literal “cL” to the empty list vs representing the contracted literal of the subject A and add “rank” to “done2”. This results in vs=cL and done2=rank.

Next, the processing proceeds to the step 407 to check whether an unprocessed base predicate is remaining. As “degree” is left as an unprocessed base predicate, the processing proceeds to the step 408 to extract it.

Next, the processing proceeds to the step 409 to extract a triple in which A is the subject and “degree” is the predicate from the original RDF data. Here, (A, degree, 4) is extracted. As 4 is smaller than 10, it turns out that the contracted literal thereof is “dL” from the contraction base table. The processing then proceeds to the step 410 to add the contracted literal “dL” to the empty list vs representing the contracted literal of the subject A and add “degree” to “done2”. This results in vs=cLdL and done2=rank degree.

Next, the processing proceeds to the step 407 and then proceeds to the step 411 because an unprocessed base predicate does not exist. In the step 411, that the contracted literal of A is “cLdL” is recorded in the contraction table. Next, the processing proceeds to the step 412 to add the subject A to “done”, followed by return to the step 403.

The processing of the steps 403 to 412 is similarly executed on the unprocessed resources B, C, D, and E in the following steps. The contraction table of FIG. 10A is generated as a result.

Next, the processing of the step 302 will be described along the flowchart shown in FIG. 5.

First, a list in which to record processed triples is created (defined as “done”) in the step 501. Next, the processing proceeds to the step 502 to create empty contracted RDF data (FIG. 10B) (defined as CG).

Next, the processing proceeds to the step 503 to check whether an unprocessed triple is remaining. As unprocessed triples are left, the processing proceeds to the step 504 to extract one triple. Suppose that (A, rank, 1) has been extracted here.

Next, the processing proceeds to the step 505 to obtain contracted literals corresponding to (A, rank, 1). The subject A and the predicate “rank” are resources and it turns out that the contracted literals thereof are “cLdL” and “rank”, respectively, according to the contraction table of FIG. 10A. Since 1 is a literal it turns out that the contracted literal thereof is “cL” according to the contraction base table of FIG. 9B. The processing then proceeds to the step 506 to add a triple (cLdL, rank, cL) composed of the obtained contracted literals to the contracted RDF data CG. The processing subsequently proceeds to the step 507 to add to the original RDF data a triple (A, abs, cLdL) representing the correspondence between the subject A and the contracted literal “cLdL”. Thereafter, the processing proceeds to the step 508 to add (A, rank, 1) to the processed triple list “done”, followed by return to the step 503.

The processing of the steps 503 to 508 is similarly executed on unprocessed triples in the following steps. The contracted RDF data of FIG. 10B is created as a result.

Next, the processing of the step 303 will be described along the flowchart shown in FIG. 6.

First, in the step 601, an input query (FIG. 9C) is converted to create a query obtained by replacing literals in the query by the corresponding contracted literals (FIG. 11A). Next, the processing proceeds to the step 602 to search the contracted RDF data (FIG. 10B) using the contracted query aq to acquire the contracted literals of the respective variables in the query (variable binding) (FIG. 11B).

Next, the processing proceeds to the step 603 to expand the input query (FIG. 9C) using the result of FIG. 11B to create an expanded query in which the search range is restricted (FIG. 11C). The processing then proceeds to the step 604 to execute the expanded query of FIG. 11C on the original RDF data (FIG. 9A) to obtain the values of the respective variables in the query (FIG. 11D). This is the same as the normal query processing executed by the RDF store.

Next, the processing proceeds to the step 605 to output the contents of FIG. 11D as the result, such that the processing is terminated.

The processing of the step 601 will be described along the flowchart shown in FIG. 7.

First, in the step 701, the contracted query having the variable node of the original query (FIG. 9C) turned to * and having the “where” clause empty is created (defined as aq). Next, the processing proceeds to the step 702 to make an empty list in which to record processed patterns (defined as “done”).

Next, the processing proceeds to the step 703 to check whether an unprocessed pattern is remaining. As unprocessed patterns are left, the processing proceeds to the step 704 to extract one pattern. Suppose that a pattern “filter (?d1<6)” has been extracted here.

Next, the processing proceeds to the step 705 to create a pattern obtained by replacing the literal included in the pattern “filter (?d1<6)” by a contracted literal with reference to the contraction base table (FIG. 9B). The included literal is only 6, and the predicate of the triple pattern in which a variable “?d1” as the counterpart of the comparison with 6 is the object is “degree”. When it is deemed as the base predicate and the contracted literal of 6 is obtained from the contraction base table, it turns out that the contracted literal is “dL”. Accordingly, the pattern obtained by the replacement is “filter (?d1<dL)”.

Next, the processing proceeds to the step 706 to add the pattern “filter (?d1<dL)” to the “where” clause of the contracted query aq. The processing then proceeds to the step 707 to add the pattern “filter (?d1<6)” to the processed pattern list “done”, followed by return to the step 703.

The processing of the steps 703 to 707 is similarly executed about unprocessed patterns in the following steps. The contracted query of FIG. 11A is created as a result.

The processing of the step 603 will be described along the flowchart shown in FIG. 8.

First, in the step 801, an empty expanded query set is created (defined as qs). Next, the processing proceeds to the step 802 to make an empty list in which to record processed variable binding (defined as “done”).

Next, the processing proceeds to the step 803 to check whether unprocessed variable binding is remaining. As only one variable binding is present, the processing proceeds to the step 804 to extract it. The processing then proceeds to the step 805 to copy the original query (FIG. 9C) to create a new query (defined as qe). Thereafter, the processing proceeds to the step 806 to make an empty list in which to record processed variables (defined as “done2”).

Next, the processing proceeds to the step 807 to check whether an unprocessed variable is remaining. As unprocessed variables are left, the processing proceeds to the step 808 to extract one variable. Suppose that a variable “?s1” has been extracted here. When the value of the variable “?s1” is checked according to the variable binding (FIG. 11B) in the following step 809, the contracted literal is found out to be “cHdL”. A pattern “?s1<abs> cHdL.” is accordingly added to the “where” clause of the new query qe.

Next, the processing proceeds to the step 810 to add the variable ?s1 to the processed variable list “done2”, followed by return to the step 807.

The processing of the steps 803 to 810 is similarly executed on unprocessed variables in the following steps, and the expanded query of FIG. 11C is created as a result. A part indicated with (*) in the expanded query shown in FIG. 11C is variable nodes of restricted range added to the original query shown in FIG. 9C.

With the expanded query (FIG. 11D) created by the working example and the original query (FIG. 9C) compared, the original query has the search range of the variables ?s1, ?s2, and ?s3 to be 5×5×5=125, which is the combinations of all of A, B, C, D, and E.

On the contrary, the variable nodes of restricted range “?s1<abs> cHdL”, “?s2<abs> cHdL”, and “?s3<abs> cLdL”, which restrict the range of the variables ?s1, ?s2, and ?s3, have been added to the expanded query created by the present working example. The values that can be taken by the variables ?s1 and ?s2 are accordingly each restricted to B and D corresponding to the contracted literal cHdL, and the value that can be taken by the variable ?s3 is restricted to E corresponding to the contracted literal cLdL. The search range of the variables ?s1, ?s2, and ?s3 is narrowed to 2×2×1=4. As a result, the expanded query has the execution efficiency significantly enhanced compared with the original query.

1. A SPARQL query optimization method for optimizing a SPARQL query by use of a computer, the method comprising the steps of:
receiving from an input device a contraction base table in which a basis to associate a plurality of literals in RDF data held by an RDF store with one value referred to as a contracted literal is defined;
generating a contraction table to associate a plurality of resources included in the RDF data with one contracted literal with reference to the contraction base table;
creating contracted RDF data obtained by integrating a plurality of nodes of the RDF data into one node and adding, to the RDF data, a triple representing a correspondence relation between a node of the RDF data and a contracted RDF node with reference to the contraction base table and the contraction table;
receiving a SPARQL query from the input device and creating a contracted query obtained by replacing a literal in the query that has been input by a corresponding contracted literal with reference to the contraction base table;
searching the contracted RDF data by use of the contracted query and generating a variable binding table in which a contracted literal possessed by each variable in the query is recorded;
creating an expanded query obtained by adding to the query a variable node of restricted range that specifies a contracted literal possessed by each variable with reference to the variable binding table that has been generated; and
searching the RDF data by use of the expanded query that has been created and obtaining a search result.

2. A storage medium that is readable by a computer, the storage medium storing a program for carrying out the method according to claim 1.

3. A computer system comprising:
an input device that receives a contraction base table in which a basis to associate a plurality of literals in RDF data held by an RDF store with one value referred to as a contracted literal is defined;
means for generating a contraction table to associate a plurality of resources included in the RDF data with one contracted literal with reference to the contraction base table;
means for creating contracted RDF data obtained by integrating a plurality of nodes of the RDF data into one node and adding to the RDF data a triple representing a correspondence relation between the node of the RDF data and a contracted RDF node with reference to the contraction base table and the contraction table;
means for receiving a SPARQL query from the input device and creating a contracted query obtained by replacing a literal in the query that has been input by a corresponding contracted literal with reference to the contraction base table;
means for searching the contracted RDF data by use of the contracted query and generating a variable binding table in which a contracted literal possessed by each variable in the query is recorded;
means for creating an expanded query obtained by adding to the query a variable node of restricted range that specifies a contracted literal possessed by each variable with reference to the variable binding table that has been generated; and
means for searching the RDF data by use of the expanded query that has been created and obtaining a search result.

4. A SPARQL query optimization method for optimizing a SPARQL query by use of a computer, the method comprising:
searching contracted RDF data obtained by contracting RDF data by use of a contracted query of a query; and
searching the RDF data by use of an expanded query obtained by converting the query with a variable binding table available as a result of the search.

5. The SPARQL query optimization method according to claim 4, comprising:
creating the contracted RDF data obtained by contracting the RDF data and generating a contraction table showing a correspondence relation between the RDF data and the contracted RDF data with reference to the contraction base table when the contracted RDF data is searched prior to search of the RDF data using the query; and
searching the contracted RDF data by use of the contracted query created from the query and generating the variable binding table as a search result with reference to the contraction table and the contraction base table.

6. The SPARQL query optimization method according to claim 4, comprising
creating the expanded query according to the query through restricting a search range with reference to the variable binding table and searching the RDF data by use of the expanded query to obtain a search result when the RDF data is searched.
